(19) United States
(12) Patent Application Publication
(10) Pub. No.: US 2007/0048559 A1
(43) Pub. Date: Mar. 1, 2007

(54) Air reservoir to dilute hydrogen emissions

(76) Inventor: Jon Beasley, Dearborn, MI (US)

Correspondence Address: TUNG & ASSOCIATES, 838 WEST LONG LAKE, SUITE 120, BLOOMFIELD HILLS, MI, 48302, US

(21) Appl. No.: 11/218,697

(22) Filed: Sep. 1, 2005

(51) Int. Cl. H01M 8/04

(52) U.S. Cl. 429/13; 429/34; 429/22

(57) ABSTRACT

A fuel cell system having an air source to dilute hydrogen emissions upon shutdown of the system is disclosed. The air reservoir includes a fuel cell stack module and a hydrogen source, a main air source and an auxiliary air source provided in fluid communication with the fuel cell stack module for diluting hydrogen emissions from the fuel cell stack module upon shutdown of the fuel cell system. A method of diluting hydrogen emissions from a fuel cell system is also disclosed.

### FIELD OF THE INVENTION

The present invention relates to fuel cell systems. More particularly, the present invention relates to a fuel cell system which includes an air reservoir for distributing air into a fuel cell stack module after normal or mandatory system shut-down to dilute hydrogen emissions from the system.

### BACKGROUND OF THE INVENTION

Fuel cells include three basic components: an anode, a cathode and a Proton Exchange Membrane (PEM). Hydrogen fuel flows into the anode, which is coated with a catalyst that strips the hydrogen into electrons and protons. Protons pass through the PEM to the cathode. Electrons cannot pass through the PEM and must travel through an external circuit, thereby producing electricity, which drives an electric motor that powers the automobile. Air flows into the cathode, where oxygen from the air combines with the hydrogen to produce water vapor, which is emitted from the tailpipe of the vehicle. Individual fuel cells can be stacked together in series to generate increasingly larger quantities of electricity.

During normal operation, an air compressor forces air into the fuel cell system. In addition to supplying oxygen to the cathode, the air forces un-reacted hydrogen from the fuel cell system through the hydrogen exhaust. Upon subsequent shutdown of the fuel cell system, the air compressor shuts off and hydrogen remaining in the system bleeds off through the hydrogen exhaust. This, however, can result in the emission of undiluted hydrogen from the fuel cell system.

One possible solution to the emission of undiluted hydrogen from the fuel cell system involves continuing operation of the air compressor for a short period of time after fuel cell shutdown to dilute the hydrogen and force the diluted hydrogen from the system through the hydrogen exhaust. This, however, is unacceptable due to noise and fuel consumption considerations.

Accordingly, a fuel cell system is needed which is provided with an air reservoir to force air through the fuel cell system after system shut-down in order to dilute hydrogen emitted from the system.

### SUMMARY OF THE INVENTION

The present invention is generally directed to a fuel cell system having an air source to dilute hydrogen emissions upon shutdown of the system. The air reservoir includes a fuel cell stack module and a hydrogen source, a main air source and an auxiliary air source provided in fluid communication with the fuel cell stack module for diluting hydrogen emissions from the fuel cell stack module upon shutdown of the fuel cell system. The present invention is further directed to a method of diluting hydrogen emissions from a fuel cell system.

### BRIEF DESCRIPTION OF THE DRAWINGS

The invention will now be described, by way of example, with reference to the accompanying drawings, in which:

FIG. 1 is a schematic diagram of a fuel cell system provided with an air reservoir to dilute hydrogen emissions according to the present invention; and

FIG. 2 is a flow diagram of sequential steps carried out according to a method of diluting hydrogen emissions from a fuel cell system according to the present invention.

### DETAILED DESCRIPTION OF THE INVENTION

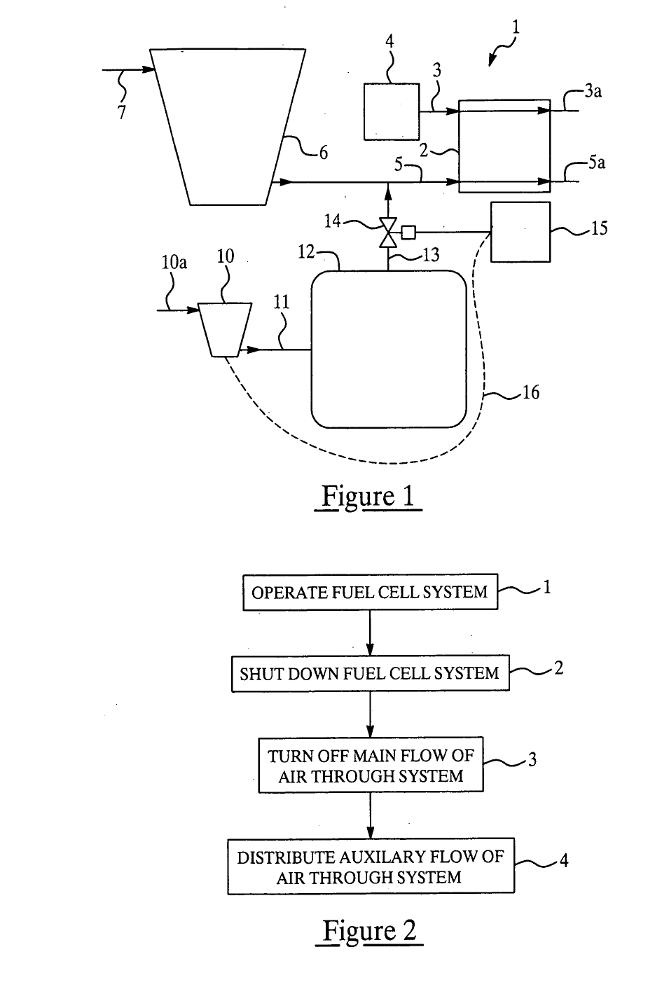

Referring initially to FIG. 1, an illustrative embodiment of a fuel cell system with air reservoir, hereinafter system, of the present invention is generally indicated by reference numeral 1. The system 1 includes a fuel cell stack module 2 which contains a fuel cell stack (not shown). A hydrogen inlet 3 is provided in fluid communication with the anode side of the fuel cell stack module 2 and is connected to a hydrogen source 4 to distribute hydrogen gas from the hydrogen source 4 into the anode side of the fuel cell stack module 2 during operation of the system 1. An air inlet 5 is provided in fluid communication with the cathode side of the fuel cell stack module 2 and is connected to a main air compressor 6 having an air inlet 7. A hydrogen exhaust outlet 3a leads from the anode side, and an air exhaust outlet 5a leads from the cathode side, of the fuel cell stack module 2. During operation of the system 1, the main air compressor 6 forces air through the air inlet 5 and into the cathode side of the fuel cell stack module 2. A controller 15 is connected to the main air compressor 6 to operate the main air compressor 6 during operation of the system 1 and terminate operation of the main air compressor 6 upon shut-down of the system 1.

According to the present invention, an auxiliary air compressor 10, having an air inlet 10a, is provided in fluid communication with an air reservoir 12 through an air inlet conduit 11. In turn, the air reservoir 12 is provided in fluid communication with the air inlet 5 through an air outlet conduit 13. The air reservoir 12 is sized in such a manner that the volume of compressed air contained therein is sufficient to dilute and force residual hydrogen from the fuel cell stack module 2 after shutdown of the system 1, as will be hereinafter described. A valve 14 is provided in the air outlet conduit 13, and the controller 15 is operably connected to the valve 14 for opening and closing of the valve 14. The controller 15 is connected to the auxiliary air compressor 10 such as by wiring 16. Accordingly, the controller 15 is programmed to operate the main air compressor 6 to force air into the cathode side of the fuel cell stack module 2 while maintaining the valve 14 in a closed position and operating the auxiliary air compressor 10 to replenish compressed air in the air reservoir 12, during operation of the system 1. The controller 15 is also programmed to terminate operation of the main air compressor 6 and open the valve 14 upon shutdown of the system 1. In an alternative embodiment (not shown), the air reservoir 12 may be omitted and the auxiliary air compressor 10 connected to the fuel cell stack module 2.

In typical operation of the system 1, the controller 15 maintains the valve 14 in the closed position and causes the auxiliary air compressor 10 to force compressed air into the air reservoir 12 through the air inlet conduit 11. The controller 15 also operates the main air compressor 6 to force air through the air inlet 5 and into the cathode side of the fuel cell stack module 2. Simultaneously, hydrogen gas is distributed from the hydrogen source 4, through the hydrogen inlet 3 and into the anode side of the fuel cell stack module 2, respectively. In the fuel cell stack module 2, electrons are harvested from the hydrogen gas at the anode (not shown) and distributed to an external circuit (not shown) containing an electric motor (not shown) to drive the motor. The protons from the hydrogen gas are passed from the anode, through a polymer electrolyte membrane (PEM, not shown) and to the cathode (not shown). At the cathode, the protons combine with oxygen from the air and the electrons returning from the external circuit to form water. The compressed air from the main air compressor 6 forces excess air and exhaust water from the fuel cell stack module 2 through the air exhaust outlet 5a. The compressed air from the main air compressor 6 also dilutes and forces residual hydrogen gas from the anode side of the fuel cell stack module 2 through the hydrogen exhaust outlet 3a.

Upon shutdown of the system 1, the controller 15 controls the main air compressor 6 to spool down and eventually terminate flow of compressed air from the main air compressor 6, through the air inlet 5 and into the cathode side of the fuel cell stack module 2. Therefore, undiluted residual hydrogen gas remains in the anode side of the fuel cell stack module 2. Simultaneously, the controller 15 opens the valve 14, causing flow of compressed air down a pressure gradient from the air reservoir 12; through the air outlet conduit 13, open valve 14 and air inlet 5, respectively; and into the cathode side of the fuel cell stack 2. The compressed air from the air reservoir 12 dilutes and forces the residual hydrogen gas from the fuel cell stack module 2 through the hydrogen exhaust outlet 3a.

Upon subsequent operation of the system 1, the controller 15 again closes the valve 14 and operates the auxiliary air compressor 10 to replenish the compressed air in the air reservoir 12. Simultaneously, the controller 15 operates the main air compressor 6 to force air through the air inlet 5 and into the cathode side of the fuel cell stack module 2. Hydrogen gas again flows from the hydrogen source 4, through the hydrogen inlet 3 and into the anode side of the fuel cell stack module 2. Upon subsequent shutdown of the system 1, the controller 15 again terminates operation of the main air compressor 6 and opens the valve 14, thereby facilitating flow of compressed air from the air reservoir 12 and into the cathode side of the fuel cell stack module 2 to dilute and force residual hydrogen gas from the fuel cell stack module 2, as was heretofore described.

Referring next to FIG. 2, a flow diagram which illustrates steps carried out according to a method of diluting hydrogen emissions from a fuel cell system of the present invention is shown. In step 1, the fuel cell system is operated to generate electrical power for an external circuit. This is carried out by harvesting electrons from hydrogen gas, distributing the electrons as electrical current through the external circuit, combining the electrons with protons and oxygen to form water, and emitting the water and residual hydrogen from the system as exhaust. A main flow of air through the fuel cell system dilutes and forces residual hydrogen from the system. In step 2, the fuel cell system is shut down. In step 3, the main flow of air through the fuel cell system is turned off. In step 4, an auxiliary flow of air is distributed through the system to dilute and force residual hydrogen from the system.

While the preferred embodiments of the invention have been described above, it will be recognized and understood that various modifications can be made in the invention and the appended claims are intended to cover all such modifications which may fall within the spirit and scope of the invention.

What is claimed is:

1. A fuel cell system comprising:
a fuel cell stack module;
a hydrogen source provided in fluid communication with said fuel cell stack module;
a main air source provided in fluid communication with said fuel cell stack module; and
an auxiliary air source provided in fluid communication with said fuel cell stack module.

2. The fuel cell system of claim 1 further comprising a controller connected to said main air source and said auxiliary air source.

3. The fuel cell system of claim 1 wherein said main air source comprises a main air compressor.

4. The fuel cell system of claim 1 wherein said auxiliary air source comprises an auxiliary air compressor.

5. The fuel cell system of claim 1 wherein said auxiliary air source comprises an air reservoir connected to said fuel cell stack module.

6. The fuel cell system of claim 5 further comprising an auxiliary air compressor connected to said air reservoir.

7. The fuel cell system of claim 6 further comprising a controller connected to said main air source and said auxiliary air compressor.

8. The fuel cell system of claim 7 further comprising a valve between said air reservoir and said fuel cell stack module.

9. A fuel cell system comprising:
a fuel cell stack module;
a hydrogen source provided in fluid communication with said fuel cell stack module;
a main air source provided in fluid communication with said fuel cell stack module;
an auxiliary air source provided in fluid communication with said fuel cell stack module;
a valve provided between said auxiliary air source and said fuel cell stack module; and
a controller connected to said main air source, said auxiliary air source and said valve.

10. The fuel cell system of claim 9 wherein said main air source comprises a main air compressor.

11. The fuel cell system of claim 9 wherein said auxiliary air source comprises an auxiliary air compressor.

12. The fuel cell system of claim 9 wherein said auxiliary air source comprises an air reservoir connected to said fuel cell stack module.

13. The fuel cell system of claim 12 further comprising an auxiliary air compressor connected to said air reservoir.

14. The fuel cell system of claim 13 wherein said controller is connected to said auxiliary air compressor.

15. The fuel cell system of claim 13 wherein said valve is provided between said air reservoir and said fuel cell stack module.

16. A method of diluting hydrogen emissions from a fuel cell system, comprising:
operating a fuel cell system while distributing a main flow of air through said fuel cell system;
shutting down said fuel cell system;
terminating distribution of said main flow of air through said fuel cell system; and
distributing an auxiliary flow of air through said fuel cell system.

17. The method of claim 16 wherein said distributing a main flow of air through said fuel cell system comprises providing a main air compressor in fluid communication with said fuel cell system and distributing said main flow of air from said main air compressor to said fuel cell system.

18. The method of claim 16 wherein said distributing an auxiliary flow of air through said fuel cell system comprises providing an air reservoir in fluid communication with said fuel cell system and distributing said auxiliary flow of air from said air reservoir to said fuel cell system.

19. The method of claim 18 further comprising replenishing air in said air reservoir.

20. The method of claim 18 further comprising providing a valve between said air reservoir and said fuel cell system and closing said valve during said operating a fuel cell system while distributing a main flow of air through said fuel cell system and opening said valve during said distributing an auxiliary flow of air through said fuel cell system.
